(19) United States
(12) Patent Application Publication
(10) Pub. No.: US 2010/0324786 A1
(43) Pub. Date: Dec. 23, 2010

(54) CONTROL UNIT AND METHOD FOR TRIGGERING A PASSENGER PROTECTION SYSTEM

(76) Inventor: Timo Weiss, Korntal (DE)

Correspondence Address: KENYON & KENYON LLP, ONE BROADWAY, NEW YORK, NY, 10004, US

(21) Appl. No.: 12/305,901

(22) PCT Filed: Dec. 28, 2007
(86) PCT No.: PCT/EP07/64608

§ 371 Date: Aug. 13, 2010

(30) Foreign Application Priority Data
Jan. 24, 2007 (DE) 10 2007 003 542.1

(51) Int. Cl. G06F 19/00

(52) U.S. Cl. 701/45

(57) ABSTRACT

A control unit and a method for triggering a passenger protection system. A sensor signal is supplied, the passenger protection system is triggered as a function of the sensor signal. The sensor signal is processed by a first and a second signal processor for generating a first and a second comparison signal. The first and the second comparison signals are compared with one another to generate an input signal for a decoder, and the decoder supplies the decoded input signal for triggering the passenger protection system.

### BACKGROUND INFORMATION

Published German patent document DE 103 42 625 describes the operation of an impact sensor at a distance from a control unit and the configuration of this impact sensor, so that it transmits its sensor data by current pulses to the control unit. The sensor is supplied with power from the control unit via a dc current over this data line.

### SUMMARY

A control unit and a method according to the present invention for triggering a passenger protection system are advantageous in that due to a special design of an interface with regard to the processing of a sensor signal, an improved integrity of the sensor signal for providing the sensor signal for further processing in the control unit is achieved, in particular with regard to variations in a bias current component due to temperature influences.

In particular, when more than one sensor is connected to the line, the bias currents of the peripheral sensors are additive and thus the corresponding bias current tolerances are also additive. The total of these tolerances may reach the level of a current excursion with which the signal is modulated. Adapting to this is a great advantage of the present control unit and method. Component tolerances may be eliminated very easily in this way.

An object of the present invention is to process the signal through two different signal processors to thereby obtain two comparison signals which are compared by a comparison device. It is thus possible to reliably detect an edge change of the sensor signal transmitted, in particular by using Manchester coding. Ultimately, according to the present invention, independence is achieved with respect to fluctuations in bias current. The control unit according to the present invention and the method according to the present invention are thus based on the bias current being used at a given moment. Sensors having different bias current uptakes may thus be exchanged with one another without requiring adjustments in hardware or software. Any fluctuation in bias current of the sensors due to production is compensated according to the present invention.

The interface according to the present invention may be implemented in hardware but may also be implemented in software. An analyzer circuit is usually a microcontroller, but other conventional controllers such as microprocessors, ASICs or other computation units are also possible. Active or passive passenger protection means such as brakes, vehicle dynamics regulation, airbags, seat-belt tighteners or crash-activated head restraints may also be used as the passenger protection system. The sensor signal is usually transmitted digitally from the sensor to the control unit. The comparison device, the first and second signal processors, a decoder circuit and the analyzer circuit may each be implemented in either hardware and/or software. Different processors, hardware configurations or software architectures may be used for this purpose.

It is advantageous that the first signal processor has a hysteresis circuit. With such a hysteresis circuit, it is possible to achieve reliable detection of an edge change, in particular in the case of a Manchester-coded signal. The hysteresis circuit may be implemented in hardware and/or software and preferably has a connection to the output of the comparison device and to the input of the comparison device. This results in feedback. A feedback path may preferably contain a multiplier element for weighting the output signal of the comparison device accordingly. The weighting may be achieved by a constant or adaptive factor. Adaptation may also be performed on the signal itself or as a function of time or other signals. The feedback signal is fed back by an adding element to an input of the comparison device. The weighted feedback signal is counted together with the incoming sensor signal by the adding element.

The second signal processor preferably includes low-pass filtering. In the simplest case, this low-pass filtering may be embodied as an RC element. However, more complex low-pass filter hardware may be provided; digital low-pass filters may be provided and in particular it is also possible to implement the low-pass filtering in software. The low-pass filtering supplies a low-pass-filtered sensor signal that is transmitted to a second input of the comparison device. The sensor signal, which is influenced by the hysteresis circuit, and the low-pass-filtered sensor signal are then compared.

The comparison device advantageously has at least one comparator. There is thus a threshold value switch which compares the signal influenced by the hysteresis circuit with the low-pass-filtered sensor signal as a threshold. A corresponding output signal is generated as a function thereof. The at least one comparator may also be implemented in software.

The interface is preferably designed as an integrated circuit. A simple and reliable means of manufacturing the interface according to the present invention is thus possible.

### BRIEF DESCRIPTION OF THE DRAWINGS

FIG. 1 shows a first block diagram of a control unit having connected components according to the present invention.

FIG. 2 shows a second control unit sensor configuration.

FIG. 3 shows a detail of a signal processor of the sensor signal according to the present invention,

FIG. 4 shows a flow chart of a method according to the present invention.

FIG. 5 shows a voltage-time diagram.

### DETAILED DESCRIPTION OF EXAMPLE EMBODIMENTS

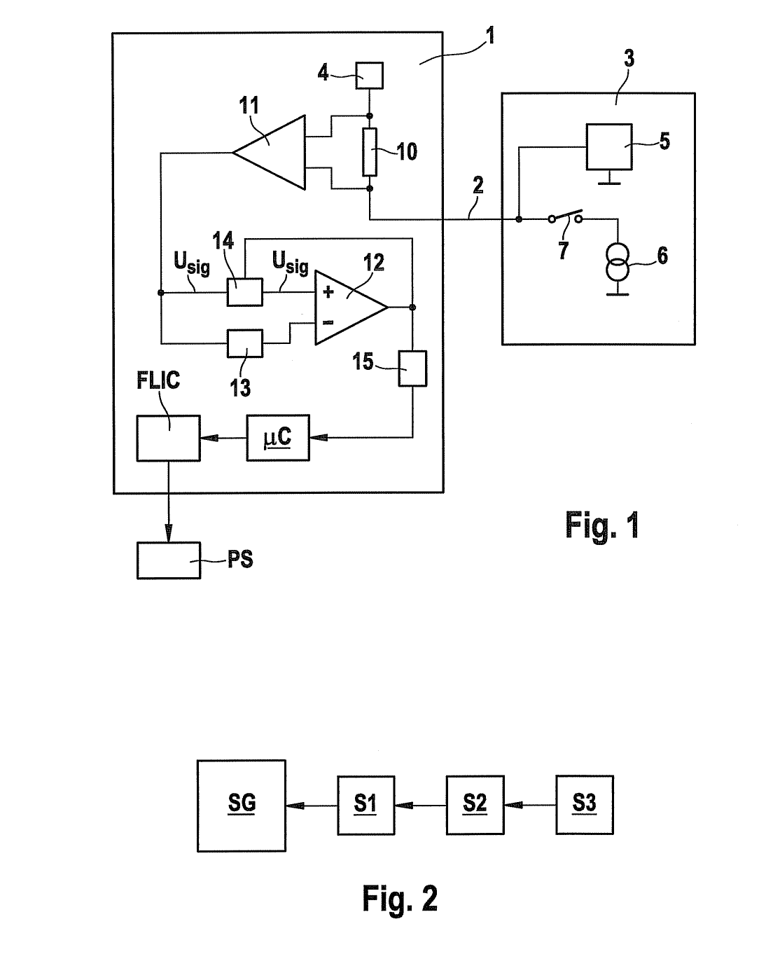

FIG. 1 shows a block diagram of a first exemplary embodiment of a control unit according to the present invention. A sensor 3, e.g., a pressure sensor, an acceleration sensor and/or a structure-borne noise sensor, transmits its signals over a line 2 to a control unit 1 for triggering passenger protection means PS. Sensor 3 is installed in the sides of a vehicle or in the front of the vehicle, for example. Control unit 1 may be located in the vehicle on the vehicle tunnel. Sensor 3 has a parallel circuit of a voltage regulator 5 on the one hand and a current generator 6 on the other hand as well as a controllable switch 7. Controllable switch 7 is controlled by a control circuit (not shown) to generate current pulses of a predefined pulse current intensity I_{excursion}. The data information may be coded in Manchester code. The current pulses thereby generated are then transmitted over data transmission line 2, namely these current pulses are superimposed on a flowing bias current of sensor 3. In control unit 1, a shunt resistor 10 is situated between a voltage source 4, e.g., a power reserve, a voltage regulator and data transmission line 2. Signal voltage U_{sig}, which drops at this resistor and is proportional to current I_{sig} flowing over data transmission line 2, is sent to a comparator 12 via an amplifier 11 and is compared there with a reference voltage U_{ref}. With a corresponding choice of U_{ref}, the status of the transmission line may be assessed at comparator 12. If signal voltage U_{sig} is lower than reference voltage U_{ref}, this indicates that no data are being transmitted at the moment and thus the bias current alone is flowing over data transmission line 2. The output of comparator 12 in this case has a low level. In addition, the output of the comparator 12 is sampled and further processed digitally by a decoder 15 to assess the transmission sequence that forms the basis of a current-modulated wave train on transmission line 2.

According to the present invention, the reference voltage is generated with the help of a first signal processor 14 and a second signal processor 13. Through this signal processing arrangement, it is possible to compensate for fluctuations in bias current in I_{sig} via variations in temperature and component. In the present case, the first signal processor 14 is implemented as a hysterisis circuit and the second signal processor 13 is implemented as a low-pass filter. Instead of the low-pass filter, timers, other filters, a software forming of the signal, digital filters and other alternatives with which those skilled in the art are familiar may be used. The hysteresis circuit may be omitted if necessary.

The low-pass filter 13 smoothes the fast edge change of the Manchester-coded sensor signal. The original Manchester signal is compared with its own low-pass-filtered version at comparator 12. After a positive or negative edge change of the communication signal, the low-pass-filtered signal requires a certain time to follow the edge change. During this time, the output signal of the comparator is positive or negative and may be analyzed by decoder 15. Comparator 12 is prevented from flipping back with the help of hysteresis circuit 14. The decoded signal may then go from decoder 15 to microcontroller μC, where it is analyzed by an analysis algorithm. As a function of this analysis, a trigger signal is generated, transmitted by triggering circuit FLIC, which has power switches, among other things, so that triggering circuit FLIC results in energization of passenger protection means PS. Additional signals may also be processed here, e.g., by other sensors or other analysis units.

FIG. 2 shows a variant of the configuration of the control unit and connected sensors S1, S2 and S3. The sensors may be connected in series, so that control unit SG successively receives the data of sensors S1, S2 and S3, which may be acceleration sensors. More than or fewer than these three sensors may also be connected. Instead of a serial connection of sensors S1 through S3, a parallel connection is also possible.

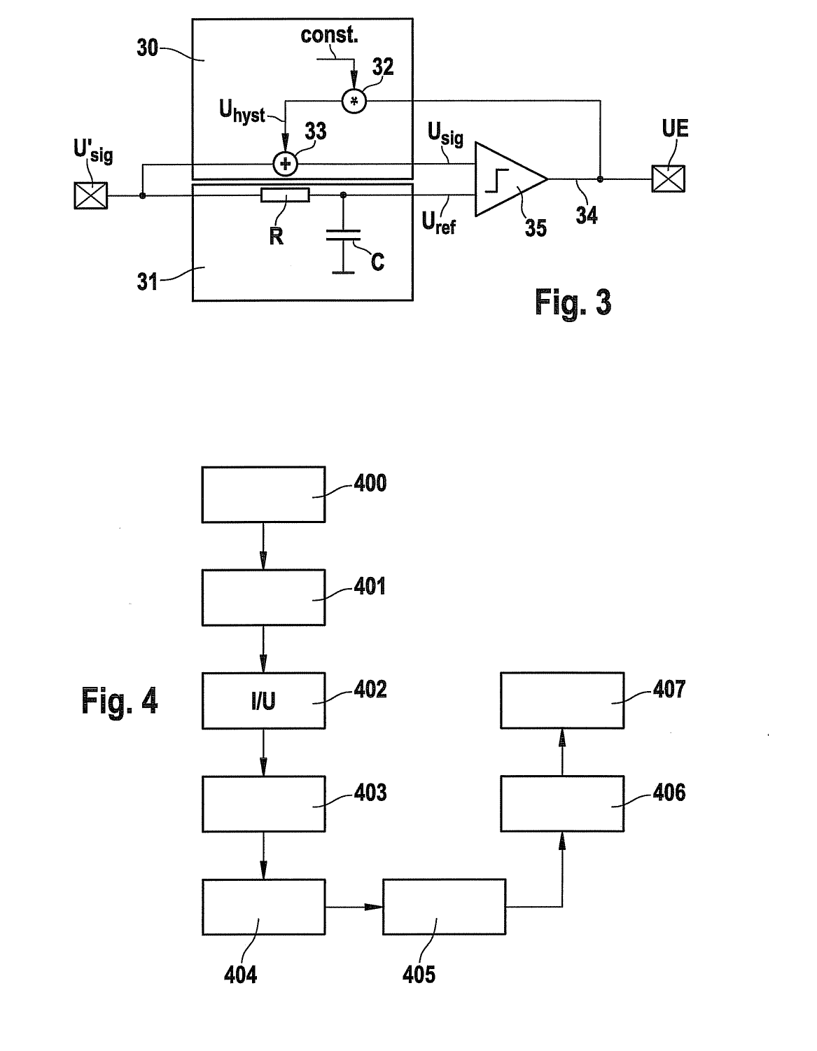

FIG. 3 shows two signal processors, a comparison device and input and output signals. The two signal processors respectively comprise a hysteresis circuit 30 and a low-pass filter 31. A comparator is provided as a comparison device 35. Input signal U′_{sig} goes first to low-pass filter 31 and then to a resistor R before going to a capacitor C connected to ground. The signal, which is low-pass filtered in this way, is labeled as U_{ref} and goes to the lower input of comparator 35. Input signal U′_{sig} also goes to hysteresis circuit 30 and to an adding element 33, which adds input signal U′_{Sig} to U_{hyst}. Resulting signal U_{sig} is input at the upper input of comparator 35. U_{sig} and U_{ref} are compared by comparator 35 and a corresponding signal 34 is output. This output signal 34, which is also labeled as UE, firstly goes to the output and secondly is fed back through hysteresis circuit 30 to the input. In doing so, it is multiplied by a constant in the feedback path, which has a multiplier element 32. Instead of a constant, a variable factor may also be used. The product is then sent to adding element 33.

It is also possible in this way to adaptively adjust to fluctuations in bias current.

FIG. 4 shows a flow chart of a method according to the present invention. In method step 400, the sensor signal is generated in the sensor. In method step 401, this sensor signal is transmitted over line 2 to control unit 1 after amplification and digitization and, if necessary, minor preprocessing. In method step 402, a current voltage conversion is performed for the additional signal processing in the control unit. In method step 403, the resulting sensor signal is processed by the first and second signal processors in the manner described above. In method step 404, the comparison signals, which are formed by the first and second signal processors, are compared. The resulting signal from the comparison device is decoded in method step 405. Input of this decoded signal into an analysis algorithm is performed in method step 406. As a function thereof, a decision about whether or not there is to be a trigger signal is made in method step 407.

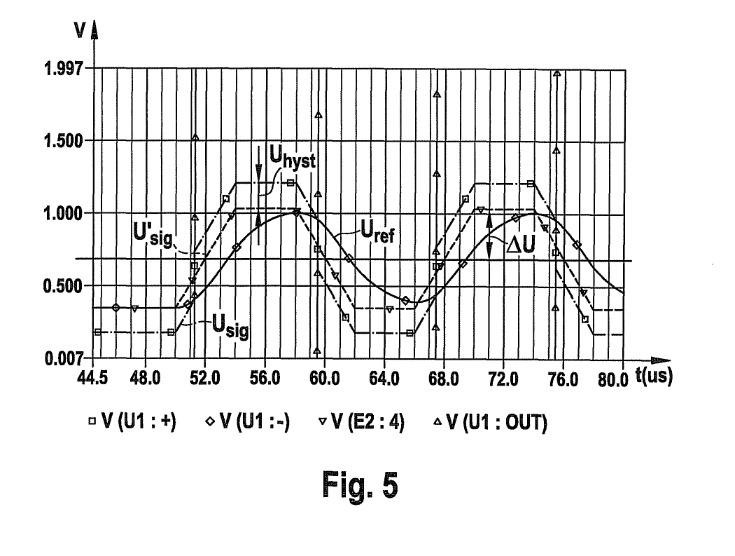

On the basis of a trapezoidal input signal U′_{sig}, FIG. 5 shows a function of the present invention. If the low-pass filter described above is used, an RC element having a time constant τ=R*C is obtained. After passing through the low-pass filter, signal U_{ref}, which is also shown in FIG. 5, is applied to the negative input of comparator 35. In the upper signal path, input signal U′_{sig} is increased or decreased by voltage U_{hyst} as a function of the output state of the comparator, so that comparator 35 has a marked hysteresis response. It is apparent that comparator 35 flips over exactly when curves U_{hyst} and U_{ref} intersect. The edge changes of the input signal, i.e., the sensor signal, are thus reliably detectable and may be converted to a stable binary output signal. Since reference voltage U_{ref} is derived directly from input voltage U′_{sig}, no presetting is necessary and thermal fluctuations in bias current are immediately compensated in the order of magnitude of τ.

In implementing the present invention, well-coordinated dimensioning of parameters T and U_{hyst} is important. The following must be considered:
1. A high time constant tau means a slow adaptivity of reference voltage U_{ref}, which has an interfering effect on the first bits of a data packet. A high tau may instead achieve a low variation in the threshold after the first data bits.
2. A low time constant tau means rapid adaptation of reference voltage U_{ref}, but also greater fluctuations in the steady state, which reduces the mean interval from U_{sig} to U_{ref} and makes the transmission more susceptible to interference.
3. A large hysteresis value U_{hyst} imparts a greater immunity to interference to the transmission system. On the other hand, there is the danger that comparator 35 may no longer be able to flip if the hysteresis is too great. This tendency becomes greater at a low τ.
4. A low hysteresis value U_{hyst} allows simple flipping of the comparator but means a greater susceptibility to interference.

1-10. (canceled)

11. A control unit for triggering a passenger protection system, comprising:
at least one interface which supplies a sensor signal, the at least one interface including a comparison device having first and second signal processors which operate on the sensor signal to respectively generate first and second comparison signals, the comparison device comparing the first and second comparison signals to generate an input signal to a decoder; and
an analyzer circuit which triggers the passenger protection system as a function of the sensor signal, wherein the decoder is connectable to the analyzer circuit for processing the decoded input signal.

12. The control unit as recited in claim 11, wherein the first signal processor has a hysteresis circuit.

13. The control unit as recited in claim 11, wherein the second signal processor has low-pass filtering.

14. The control unit as recited in claim 11, wherein the comparison device has at least one comparator.

15. The control unit as recited in claim 11, wherein the at least one interface is an integrated circuit.

16. The control unit as recited in claim 12, wherein the hysteresis circuit is connected to both an output and an input of the comparison device via an adding element, the hysteresis circuit including a multiplier element operating on the output of the comparison device.

17. A method for triggering a passenger protection system, comprising:
supplying a sensor signal; and
triggering the passenger protection system as a function of the sensor signal, wherein the supplying of the sensor signal comprises:
processing the sensor signal using first and second signal processors to respectively generate first and second comparison signals, and
comparing the first and second comparison signals with one another to generate an input signal to a decoder which supplies a decoded input signal for triggering the passenger protection system.

18. The method as recited in claim 17, wherein the first signal processor uses a hysteresis.

19. The method as recited in claim 17, wherein the second signal processor uses low-pass filtering.

20. The method as recited in claim 18, wherein the first signal processor produces the hysteresis by multiplying an output signal of a comparison device that operates on the first comparison signal, and by adding a result of the multiplying to the first comparison signal.
